(19) United States
(12) Patent Application Publication
(10) Pub. No.: US 2012/0049627 A1
(43) Pub. Date: Mar. 1, 2012

(54) CURRENT COLLECTING BOX FOR PHOTOVOLTAIC POWER GENERATION

(75) Inventors: Takahisa MATSUO, Osaka (JP); Shuhei NISHIKAWA, Osaka (JP); Tsuyoshi SEKINE, Osaka (JP)

(73) Assignee: SANYO ELECTRIC CO., LTD., Moriguchi City (JP)

(21) Appl. No.: 12/862,307

(22) Filed: Aug. 24, 2010

(51) Int. Cl. H02J 1/12

(52) U.S. Cl. 307/43

(57) ABSTRACT

A current collecting box for photovoltaic power generation comprising a ground fault detector detecting a ground fault in photovoltaic strings; a switch disposed for each of the photovoltaic strings and interposed between the photovoltaic string and a connecting cable; a control circuit determining the presence of a ground fault and providing an on/off control of the switch; and a power supply supplying the current to the grand fault detector, and the power supply is supplied from a power supply so that the operation check for the ground fault detector is performed based on an output from the ground fault detector. The current supply is supplied and the operation check for an auxiliary switch operating according to an on/off operation of a main switch is performed so that the operation check for a switch is performed.

### BACKGROUND OF THE INVENTION

1. Field of the Invention

The present invention relates to a current collecting box for photovoltaic power generation. Particularly, the invention relates to a current collecting box for photovoltaic power generation employed by a photovoltaic power generation apparatus which comprises: a photovoltaic string including a plurality of photovoltaic modules; a current collecting box for collecting direct current power from each of photovoltaic strings; and a power conditioner that converts the direct current power supplied from the current collecting box to an alternating current power and outputs the electricity.

2. Description of the Prior Art

A photovoltaic cell generates direct current power by converting the natural energy into electrical energy. With increasing awareness of the recent environmental issues, a photovoltaic power generation apparatus has received attention as a clean power generation apparatus emitting no carbon dioxide which contributes to the global warming.

A large scale photovoltaic power generation system of current interest, such as a mega solar system, aims at achieving an output of more than 1000 kW and includes thousands of photovoltaic modules having an output on the order of 200 W and interconnected to form arrays.

By the way, the above-described photovoltaic power generation system may sometimes encounter a ground fault resulting from the deterioration of insulation performance of the photovoltaic modules, wirings or the like, that are induced by some factors including the installation environment, usage conditions and the like. In the event of a ground fault, it is necessary to locate a poorly insulated part and take an appropriate measure.

U.S. Pat. No. 6,593,520 discloses a photovoltaic power generation apparatus having photovoltaic strings arranged such that in the event of a ground fault in part of a photovoltaic array, only a failed photovoltaic string is disconnected from the photovoltaic power generation apparatus. This way, the operation of the photovoltaic power generation apparatus as a whole is not suspended.

This photovoltaic power generation apparatus includes a current collecting box for collecting output electricity from a plurality of photovoltaic strings where each of the photovoltaic strings has a plurality of photovoltaic panels connected in series. The current collecting box includes: a detector for sending a failure detection signal upon detection of a failure in any one of the plural photovoltaic strings; an intermediate switch that shifts to an open state upon receiving the failure detection signal from the detector; and string switches capable of disconnecting respective photovoltaic strings. The string switch is configured to shift to an open state upon receiving the failure detection signal.

By the way, in the above-mentioned system, if a trouble occurs in a detector that detects a ground fault, the ground fault cannot be accurately detected. Furthermore, once a trouble occurs in a switch that disconnects a failed photovoltaic string, problems arise, for example, the switch cannot disconnect a failed photovoltaic string due to the failure of the switch, or normal photovoltaic string cannot be connected to the system.

### SUMMARY OF THE INVENTION

In view of the foregoing problems, the invention aims at providing with a current collecting box for photovoltaic power generation which evaluates the condition of a grand fault detector and a switch of a current collecting box for photovoltaic power generation, and detects a ground fault properly.

According to the invention, a current collecting box for photovoltaic power generation serving to collect electric power from a plurality of photovoltaic strings, comprises: a detector for providing with a detection output based on a differential current generated in a forward current cable and a backward current cable to detect a ground fault in each of the photovoltaic strings; a switch interposed between the photovoltaic string and a connecting cable; a judgment maker for determining the presence of a ground fault corresponding to an output sent from the detector; a control unit performing an on/off control to the switch according to a detection result supplied from the judgment maker, and a current supply portion for supplying the current to the detector, wherein the current is supplied from the current supply portion, and the control unit performs the operation check for the detector based on an output from the judgment maker.

According to the invention, a current collecting box for photovoltaic power generation serving to collect electric power from a plurality of photovoltaic strings, comprises: a detector for providing a detection output based on a differential current generated in a forward current cable and a backward current cable to detect a ground fault in each of the photovoltaic strings; a switch provided in correspondence to each of the photovoltaic strings and interposed between the photovoltaic string and a connecting cable; a judgment maker for determining the presence of a ground fault corresponding to an output from the detector; a control unit applying an on/off control to the switch according to a detection result supplied from the judgment maker or to a demand for the operation check; an auxiliary switch that operates according to an on/off operation at the switch; and a switch operation check portion for outputting a state of the on/off state according to an on/off operation of the auxiliary switch, wherein the control unit performs the operation check for the switch based on an output from the switch operation check portion according to a demand for the operation check.

According to the invention, it is possible to check readily whether the ground fault detector and the switch of the current collecting box for photovoltaic power generation operate normally so that the problems caused by a failure can be eliminated and appropriate measures to the ground fault can be taken.

### BRIEF DESCRIPTION OF THE DRAWINGS

FIG. 1 A schematic diagram showing a general arrangement of a photovoltaic power generation apparatus according to an embodiment of the invention;

FIG. 2 A schematic block diagram showing the detail of a part including photovoltaic strings and a current collecting box according to the embodiment of the invention;

FIG. 3 A schematic block diagram showing the detail of a part including photovoltaic strings and a current collecting box according to another embodiment of the invention.

The foregoing and other objects, features, aspects and advantages of the present invention will become more apparent from the following detailed description of the present invention when reviewed in conjunction with the accompanying drawings.

### DETAILED DESCRIPTION OF THE PREFERRED EMBODIMENTS

The preferred embodiments of the invention will be described in detail with reference to the accompanying drawings. It is noted that identical or equivalent elements in the drawings will be referred to by like reference numerals and will be explained only once to avoid repetition.

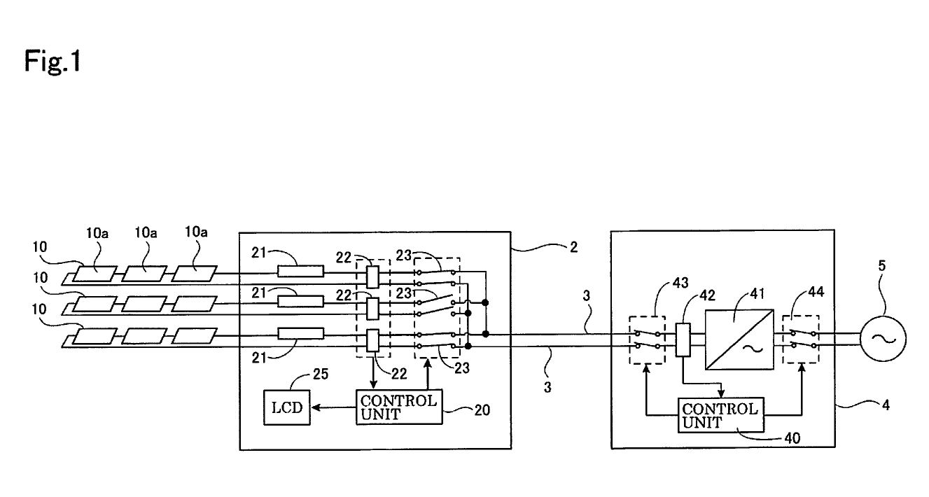

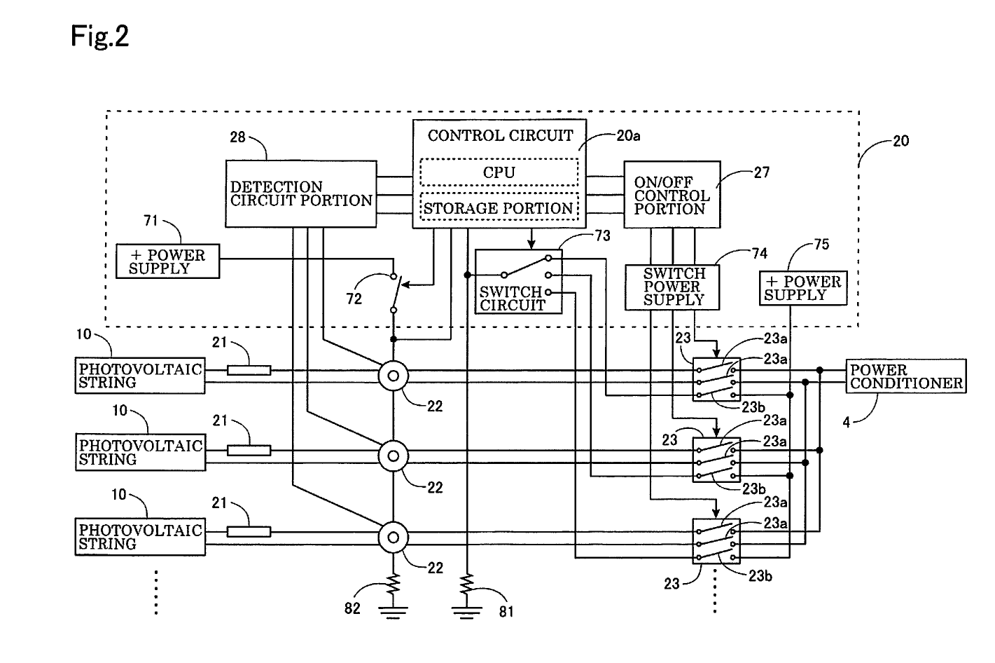

FIG. 1 is a schematic diagram showing a principal arrangement of the photovoltaic power generation apparatus according to the invention. FIG. 2 is a schematic block diagram showing the detail of a part including photovoltaic strings and a current collecting box.

As shown in FIG. 1, the photovoltaic power generation apparatus according to the embodiment comprises a photovoltaic string 10 including a plurality of photovoltaic modules 10a connected in series. A current collecting box for photovoltaic power generation (hereinafter, called “a current collecting box”) 2 is connected to a plurality of photovoltaic strings 10 so as to collect direct current outputs from the respective photovoltaic string 10. Outputs from the current collecting box 2 are supplied to a power conditioner 4 via a connecting cable 3. Direct current power generated by photovoltaic cells is converted into alternating current power by an inverter 41 disposed in the power conditioner 4 and outputted to a system 5.

In the current collecting box 2, the switch 23 is provided in one-on-one correspondence to the photovoltaic string 10 so as to disconnect the corresponding photovoltaic string 10 from the circuit when the photovoltaic modules 10a and the like are given a maintenance check or when some failure such as ground fault arises in a part of the photovoltaic string 10. An on/off control of the switch 23 is provided by the control unit 20 constituted by a microcomputer or the like. The switch 23 is capable of carrying and breaking the maximum current the photovoltaic string can supply and the open/close operation is carried out electronically. When the switch 23 is in an on state, namely, the state that the electric power is supplied from the photovoltaic string 10, an on-current is passed through the switch 23 which is maintained in a closed position. When the switch 23 is in an off state, in other word, the state that the power supply thereto is cut off, a control is provided to cut off the power supply to the switch 23 which is maintained in an open position. The switch 23 comprises an electromagnetic relay and the like which turns on/off interchangeably by a signal from the control unit 20. As described above, the switch 23 is on when supplied with the electric power, but is off when the power supply thereto is cut off.

A protection element 21 such as fuse or backflow protection diode is provided in the current collecting box 2 corresponding to each of photovoltaic strings 10. The protection element serves to prevent current backflow resulting from different voltages generated in the individual photovoltaic strings 10 due to different installation positions of the photovoltaic strings 10 or different sunlight radiation conditions.

A ground fault detector 22 for ground fault detection is interposed between a respective pair of switch 23 and photovoltaic string 10. The ground fault detector 22 detects a differential current between a forward current cable and a backward current cable based on magnetic fields generated in these cables, and applies a detection signal to a ground fault detection circuit portion. The ground fault detection circuit portion is previously supplied with a set value according to a detection sensitivity, if the detection result is equal to or more than the set value, the ground fault detection circuit portion outputs a signal indicating the occurrence of ground fault to the control unit 20. A predetermined set value according to the detection sensitivity is given to the ground fault detection circuit portion. When the detection result exceeds the set value, a signal that notifies an occurrence of a ground fault is sent to the control unit 20. The detection sensitivity of the ground fault detection circuit unit is determined corresponding to a noise superimposed on the cable connected to the photovoltaic string 10 or the like. The control unit 20 determines which one of the photovoltaic strings 10 is affected by a ground fault based on an output from the ground fault detector 22. Moreover, the ground fault detector 22 may employ a clamp-on current sensor for detecting the differential current, instead of utilizing the above-mentioned magnetic field.

Upon obtaining the signal indicating the occurrence of a ground fault, the control unit 20 turns off the switch 23 connected to the photovoltaic string 10 that is affected by the ground fault. In other word, the control unit 20 controls to break the electrical circuit. The control unit 20 cuts off the power supply to the corresponding switch 23 so as to turn off the same. The switch 23 is controlled by the control unit 20 so as to cut off the power supply from the photovoltaic string 10 that is affected by the ground fault.

The control unit 20 stores, in an internal storage device thereof, information concerning the occurrence of ground fault and the photovoltaic string 10 suffering the ground fault and displays the information on a display unit 25 comprising a liquid crystal display (LCD) or the like. The control unit also sends the information concerning the current collecting box 2, the occurrence of ground fault and the photovoltaic string 10 affected by the ground fault to a main control unit (not shown).

The control unit 20 is provided with a power supply portion. When the electric power is supplied from the photovoltaic strings 10, part of the supplied electric power is supplied to the power supply portion. When the photovoltaic strings 10 do not supply the electric power to the power supply portion, the electric power is supplied from the system 5. The power supply portion may be provided with a secondary battery which is charged with the electric power from either the photovoltaic strings 10 or the system 5. The power supply portion may be adapted to apply the charged power to the operation of the control unit 20 and the like.

As shown in FIG. 1, the power conditioner 4 is supplied with the electric power from the current collecting box 2 via the connecting cables 3. The power conditioner 4 supplies the electric power from the connecting cables 3 to the inverter 41 via a switch 43 and a ground fault detector 42. The inverter 41 converts the supplied direct current power into the alternating current power. The inverter 41 outputs the alternating current power to the system 5 via a switch 44. The on/off state of the switches 43, 44 is controlled by the control unit 40. As described above, the plural photovoltaic strings 10 are connected to the current collecting box 2, and the plural current collecting boxes 2 are connected to the power conditioner 4.

The ground fault detector 42 for ground fault detection is interposed between the switch 43 and the inverter 41. The ground fault detector 42 detects the differential current between the forward current cable and the backward current cable based on the magnetic fields generated in these cables and outputs to the control unit 40 a signal indicating the occurrence of ground fault if the detection result is equal to or more than a constant value.

Based on the output from the ground fault detector 42, the control unit 40 can determine whether or not a ground fault is present between the current collecting box 2 and the power conditioner 4. Instead of utilizing the magnetic field, the ground fault detector 42 may employ a clamp-on current sensor for detecting the differential current.

Upon obtaining the signal indicating the occurrence of a ground fault from the ground fault detector 42, the control unit 40 turnes off the switch 43 that connects the inverter 41 with the connecting cable 3, and the switch 44 that connects the inverter 41 with the system 5, respectively. Namely the control unit 40 cuts off the power supply to the switches 43, 44 so as to break the circuit. When supplied with the electric power, the switches 43, 44 are switched on so as to maintain the electrical connection. When the power supply to the switches 43, 44 is cut off, the switches 43, 44 are switched off to break the electrical connection.

Upon detection of the ground fault, the control unit 40 stops controlling the inverter 41 and deactivates the same. Subsequently, the control unit switches off the switch 44 to break the electrical connection between the power conditioner 4 and the system 5. Then, the control unit switches off the switch 43 to break the electrical connection between the inverter 41 and the connecting cable 3.

FIG. 2 is a schematic block diagram showing the detail of a part including photovoltaic strings and a current collecting box according to the embodiment of the invention. The control unit 20 includes a control circuit 20a constituted by a microcomputer. The control circuit 20a contains a storage portion including a CPU (Central Processing Unit), a ROM (Read Only Memory) and a RAM (Random Access Memory). The ROM of the storage portion, for example, contains programs for controlling the operations of the current collecting box 2 which include the ground fault detection, the on/off control of the switch 23 and the operation check for the ground fault detector 22 and the switch 23, and the like. Upon detection of the ground fault, the control circuit 20a executes programs for detecting the ground fault, identifying a corresponding photovoltaic string 10, switching off the switches 23, and transmitting a failure signal, and controls the individual operations.

Current power from the photovoltaic string 10 is supplied to each corresponding switch 23. A ground fault detector 22 for ground fault detection is interposed between a respective pair of switch 23 and photovoltaic string 10. The ground fault detector 22 detects a differential current between a forward current cable and a backward current cable based on magnetic fields generated in these cables and outputs to a detection circuit portion (judgment maker) 28. In the detection circuit portion 28, the value detected from the ground fault detector 22 is supplied to the lowpass filter (not shown) and the like for noise reduction before supplied to the control circuit 20a. The control circuit 20a is given a predetermined set value corresponding to the detection sensitivity, and determines the presence of ground fault by comparing the detection result with the set value.

According to the embodiment, it is configured such that a test current is supplied to all ground fault detectors 22 from a power supply 71 so as to perform an operation check (i.e., failure evaluation) for the ground fault detector 22. Upon evaluating a failure, on-signal is supplied to a switch 72 via a control circuit 20a so as to turn on the switch 72. When the switch 72 is turned on, the predetermined test current flows from the power supply 71.

The control circuit 20a detects which one of the photovoltaic strings 10 suffers a ground fault based on an output from the detection circuit portion 28. A control signal for switching off the corresponding switch 23 is sent to an on/off control portion 27 which applies an on/off control to the switch 23. The on/off control portion 27 cuts off the current supply to the switch 23 to be turned off, and turns off the switch 23 so as to break (i.e., open circuit) the connection with the photovoltaic string 10 and the connecting cable 3.

The switch 23 is provided in correspondence to each of the photovoltaic strings 10 and interposed between the photovoltaic string 10 and the connecting cable 3. Each switch 23 is supplied with a respective driving current from a switch power supply 74. The driving current from the switch power supply 74 is controlled by the on/off control portion 27 so that in the event of a ground fault, the power supply to the corresponding switch 23 is cut off and the switch 23 is turned off.

According to the embodiment, the switch 23 includes a main switch 23a which performs connection/cutoff with the connecting cable 3 and the photovoltaic string 10, and an auxiliary switch 23b which operates corresponding to the on/off operation of the main switch 23a. In this embodiment, the main switch 23a and the auxiliary switch 23b carry out the same operations. That is, when the main switch 23a is on, the auxiliary switch 23b is also on. When the main switch 23a is off, the auxiliary switch 23b is also off.

A power supply 75 is connected to one terminal of the auxiliary switch 23b, and a switch circuit 73 is connected to the other terminal thereof. The switch circuit 73 permits the control circuit 20a to check the on/off state of each auxiliary switch 23b.

Next, the operation check in the current collecting box for photovoltaic power generation 2 according to the embodiment is described. In checking the operation of the ground fault detector 22, the check is performed more accurately when a current power from the photovoltaic strings 10 is not supplied. Therefore, it is preferable to perform the operation check for the ground fault detector 22 during the nighttime period when the photovoltaic strings 10 do not generate the electric power.

When the operation of the ground fault detector is checked, the control circuit 20a turns on the switch 72 and carries the predetermined test current to each ground fault detector 22 from the power supply 71. The ground fault detector 22 provides a detection output corresponding to the test current to the detection circuit portion 28.

The control circuit 20a recognizes whether the ground fault detector 22 is operating correctly or the ground fault detector 22 is broken, by fetching an output from the detection circuit portion 28 one by one.

Next, the operation check for the switch 23 is described. It is also preferable to perform the operation check for the switch 23 during the nighttime period when the photovoltaic strings 10 do not generate the electric power.

Firstly, in the operation check process for the switch 23, the switch power supply 74 is controlled to cut off a current supply to all switches 23 by the control circuit 20a through the on/off control portion 27. If all switches 23 are in normal condition, all switches 23 are off.

A control circuit 20a controls the switch circuit 73 and examines an output from the auxiliary switch 23b one by one. In a case that the switch 23 is broken, the predetermined voltage supplied from the power supply 75 and a resistor 81 is outputted to the control circuit 20a because the auxiliary switch 23b is maintained in an on state. By determining this output, the switch 23 which remains in an on state without turning off can be detected. In this way, the defective switch 23 that does not turn off can be identified.

Next, the switch power supply 74 is controlled to turn on a current supply to all switches 23 by the control circuit 20a through the on/off control portion 27. If all 23 switches are in normal condition, all switches 22 are in an on state.

The control circuit 20a controls the switch circuit 73 and examines an output from the auxiliary switch 23b one by one. In a case the switch 23 is broken, the predetermined voltage supplied from the power supply 75 and the resistor 81 is not outputted to the control circuit 20a because the auxiliary switch 23b is maintained in an off state. By determining this output, the switch 23 which remains in an off state without turning on can be detected. In this way, the defective switch 23 that does not turn on can be identified.

An evaluation of a trouble can be performed by carrying out a series of the operation check for the ground fault detector 22 and the switch 23.

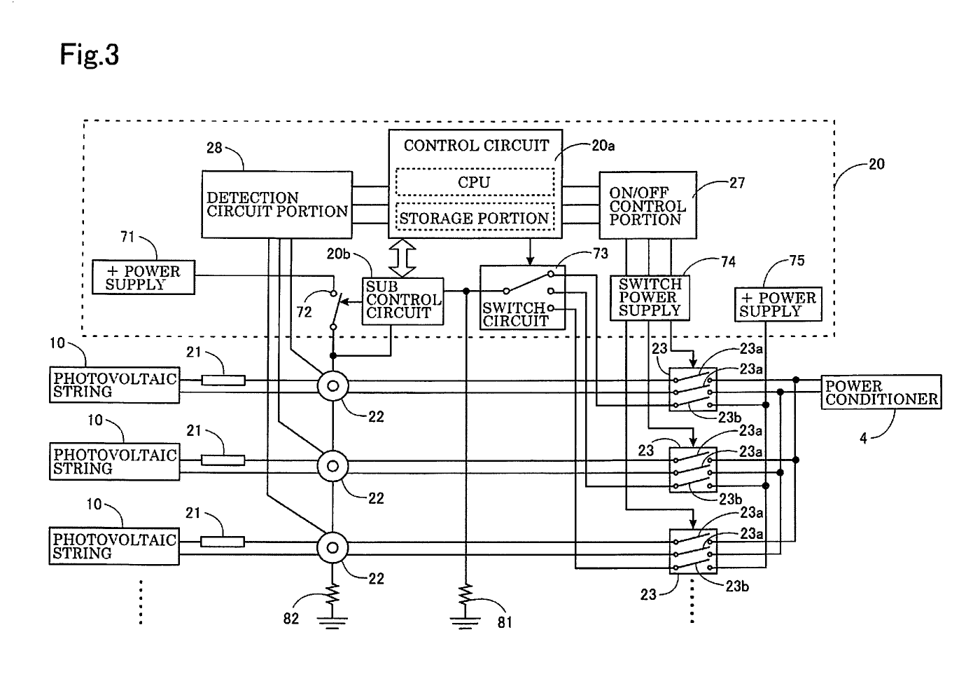

Next, another embodiment of the invention is described with reference to FIG. 3. The embodiment shown in FIG. 3 comprises a control unit 20 including a main control circuit 20a constituted by a microcomputer and a sub control circuit 20b constituted by a microcomputer. The embodiment is configured such that the main control circuit 20a performs a regular controlling operation, and the sub control circuit 20b performs an evaluating operation. Because another configures are same as those shown in FIG. 2, same reference numerals are given to the same elements and descriptions are omitted.

As described above, the control unit 20 is provided with two control circuits each including a microcomputer. The control unit is configured such that information can be sent and received mutually between the two control circuits. Information on a defective ground fault detector 22 and a defective switch 23 is supplied to the main control circuit 20a from the sub control circuit 20b so that the main control circuit can share information on the failure.

Then, both control circuits 20a and 20b can monitor their failures each other by making it possible to send and receive a data therebetween.

It should be understood that the embodiments disclosed herein are to be taken as examples in every point and are not limited. The scope of the present invention is defined not by the above described embodiments but by the appended claims. All changes that fall within means and bounds of the claims or equivalence of such means and bounds are intended to be embraced by the claims.

1. A current collecting box for photovoltaic power generation that serves to collect electric power from a plurality of photovoltaic strings, comprising:
a detector that provides with a detection output based on a differential current generated in a forward current cable and a backward current cable to detect a ground fault in each of the photovoltaic strings;
a switch interposed between the photovoltaic string and a connecting cable;
a judgment maker that determines the presence of a ground fault corresponding to an output supplied from the detector;
a control unit that applies an on/off control to the switch according to a detection result supplied from the judgment maker, and
a current supply portion that supplies the current to the detector,
wherein the current is supplied from the current supply portion, and the control unit performs the operation check for the detector based on an output supplied from the judgment maker.

2. A current collecting box for photovoltaic power generation that serves to collect electric power from a plurality of photovoltaic strings, comprising:
a detector that provides with a detection output based on a differential current generated in a forward current cable and a backward current cable to detect a ground fault in each of the photovoltaic strings;
a switch provided in correspondence to each of the photovoltaic strings and interposed between the photovoltaic string and a connecting cable;
a judgment maker that determines the presence of a ground fault corresponding to an output supplied from the detector;
a control unit that applies an on/off control to the switch according to a detection result supplied from the judgment maker or a demand for the operation check;
an auxiliary switch that operates according to an on/off operation with the switch; and
a switch operation check portion that outputs a state of the on/off state according to an on/off operation of the auxiliary switch,
wherein the control unit performs the operation check for the switch based on an output supplied from the switch operation check portion corresponding to a demand for the operation check.
